(19) United States
(12) Patent Application Publication
(10) Pub. No.: US 2007/0026173 A1
(43) Pub. Date: Feb. 1, 2007

(54) Multilayer containers and methods of manufacture

(75) Inventors: Tasadduq Hussain, Maumee, OH (US); Peter J. Draughon, Toledo, OH (US); Billy J. Hesser, Toledo, OH (US)

Correspondence Address: OWENS-ILLINOIS, INC., ONE MICHAEL OWENS WAY, THREE O-I PLAZA, PERRYSBURG, OH, 43551-2999, US

(73) Assignee: Owens-Illinois HealthCare Packaging Inc.

(21) Appl. No.: 11/190,454

(22) Filed: Jul. 27, 2005

(51) Int. Cl. B32B 27/08; B29C 49/00

(52) U.S. Cl. 428/35.7; 264/510; 264/523

(57) ABSTRACT

A blow molded plastic container includes a multilayer sidewall having at least three consecutive layers A, B and C. Layers A and C are of identical plastic composition, and of a composition different from layer B. In exemplary embodiments of the disclosure: (1) layers A and C are of a composition selected from the group consisting of cyclic olefin polymers, cyclic olefin copolymers, acrylonitriles and blends thereof, and the layer B is of a composition selected from the group consisting of cyclic olefin polymers, cyclic olefin copolymers, polycarbonates and blends thereof; (2) layers A and C are of a composition selected from the group consisting of polycarbonates acrylonitriles and blends thereof, while layer B is of a composition selected from the group consisting of nylons, polycarbonate and blends thereof; and (3) layers A and C are of acrylonitrile composition, and layer B is of ethylene vinyl alcohol composition.

The present disclosure relates to manufacture of multilayer plastic containers having particular application for use in the pharmaceutical industry.

### BACKGROUND AND SUMMARY OF THE DISCLOSURE

Containers or vials for the pharmaceutical industry typically are of glass construction, which provides high clarity, moisture and oxygen permeation resistance, heat resistance for sterilization and retort applications, and chemical resistance. However, the glass containers are highly susceptible to breakage. It has been proposed to provide multilayer plastic containers for the pharmaceutical industry that have the benefits of glass containers and additionally are of significantly reduced susceptibility to breakage. Such multilayer plastic containers have been of three-layer construction, consisting of inner and outer layers of polycarbonate with an intermediate barrier layer of nylon, inner and outer layers of polycarbonate or polyethylene with an intermediate barrier layer of cyclic olefin copolymer, and inner and outer layers of cyclic olefin copolymer with an intermediate barrier layer of nylon.

The present disclosure embodies a number of aspects that can be implemented separately from or in combination with each other.

A blow molded plastic container in accordance with of the present disclosure includes a multilayer sidewall having at least three consecutive layers A, B and C. Layers A and C are of identical plastic composition, and of a composition different from layer B. Layers A and C in accordance with one aspect of the disclosure are of a composition selected from the group consisting of cyclic olefin polymers, cyclic olefin copolymers, acrylonitriles (i.e., acrylonitrile-based materials), and blends thereof, and layer B is of a composition selected from the group consisting of cyclic olefin polymers, cyclic olefin copolymers, polycarbonates and blends thereof. In accordance with another aspect of the disclosure, layers A and C are of a composition selected from the group consisting of polycarbonates, acrylonitriles and blends thereof, while layer B is of a composition selected from the group consisting of nylons, polycarbonates and blends thereof. In accordance with a third aspect of the disclosure, layers A and C are of acrylonitrile composition, and layer B is of ethylene vinyl alcohol composition.

In accordance with a further aspect of the disclosure, the plastic materials for the container layers are fed to a molding system through respective extruders. Inert gas is fed through at least the extruder associated with layer B to prevent oxidation of the layer material during the extrusion process. In accordance with another aspect of the disclosure, the container is blow molded from a preform, and heat is applied to the blow mold independently of the preform. This feature provides enhanced control of the container properties. Gas under pressure is applied to the preform during the blow molding operation, and the gas preferably is conditioned further to enhance the container properties.

### BRIEF DESCRIPTION OF THE DRAWINGS

The disclosure, together with additional objects, features, advantages and aspects thereof, will best be understood from the following description, the appended claims and the accompanying drawings, in which:

FIG. 1 is a side elevational view of a container in accordance with an exemplary embodiment of the disclosure;

FIG. 2 is a fragmentary sectional view of the portion of FIG. 1 within the area 2;

FIG. 3 is a fragmentary sectional view that illustrates a modification to the embodiment of FIG. 2;

FIG. 4 is a schematic diagram of a system for forming a container in accordance with one aspect of the present disclosure; and

FIG. 5 is a schematic diagram of a blow mold system in accordance with another aspect of the present disclosure.

### DETAILED DESCRIPTION OF PREFERED EMBODIMENTS

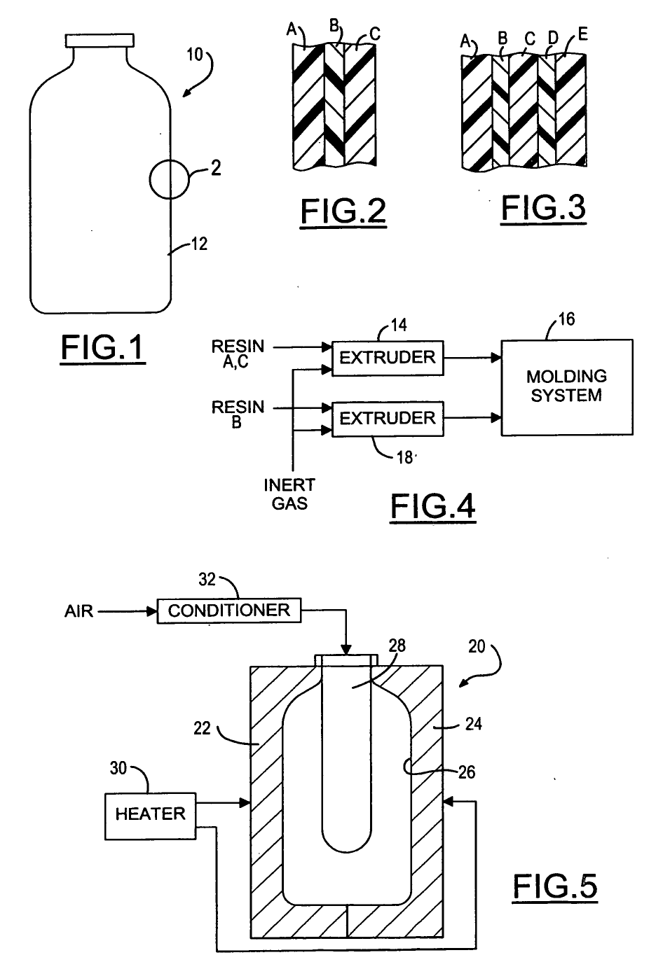

FIG. 1 illustrates a container 10 in accordance with an exemplary implementation of the disclosure. The illustrated geometry of the container 10 is exemplary only. At least the container sidewall 12 is of multilayerconstruction. One such construction is illustrated in FIG. 2, and includes three consecutive layers A, B and C. Layer A in this embodiment is the innermost layer with respect to the container or interior, while layer C is the outermost layer. Layers A and C are structural or matrix layers that provide the primary sidewall support. Layer B, the intermediate layer, is of a barrier resin material or material blend to prevent migration of moisture and/or gases through the container sidewall into and out of the container. The layers are not illustrated to scale in FIG. 2 (or FIG. 3). Barrier layer B preferably extends throughout the length of container sidewall 12, preferably extends throughout the container bottom, and may or may not extend into and/or through the neck finish portion of the container.

FIG. 3 illustrates a five-layer alternative to the three-layer construction of FIG. 2. Again there are three consecutive layers A, B, C, with additional consecutive layers D and E. In this embodiment, layer A is the innermost layer, layer E is the outermost layer, layer C is the middle layer, and layers B and D are intermediate layers. Layer B is of barrier material, while layers A, C, E are of structural or matrix resin construction. Layer D may be of barrier material, or may be of process regrind or post consumer resin construction for example. Other multilayer configurations are envisioned, the only requirement being that there are (at least) three consecutive layers A, B and C.

In each embodiment of the disclosure, layers A and C are of identical plastic composition, and are of a plastic composition different from layer B. In one embodiment of the disclosure, layers A and C are of a composition selected from the group consisting of cyclic olefin polymers (COPs), cyclic olefin copolymers (COCs) and acrylonitriles, while layer B is of a composition selected from the group consisting of cyclic olefin polymers, cyclic olefin copolymers and polycarbonates (PCs). (Inasmuch as layer B is of a composition different from layers A and C, it will be understood that, if layers A and C are of cyclic olefin copolymer, for example, layers B must be of polycarbonate composition in this example.). In another aspect of the disclosure, layers A and C are of a composition selected from the group consisting of polycarbonates and acrylonitriles, while layer B is of a composition selected from the group consisting of nylons and polycarbonates. In a third aspect of the disclosure, layers A and C are of acrylonitrile composition, while layer B is of ethylene vinyl alcohol (EVOH) composition. All of these embodiments provide one or more of the desired properties of the container, such as high clarity, moisture and oxygen permeation resistance, heat resistance for sterilization and retort applications, chemical (e.g., oil and lipids) resistance, gamma radiation resistance, breakage resistance, etc.

The containers of the present disclosure can be fabricated in any suitable molding operation, including but not limited to injection blow molding, reheat blow molding, extrusion blow molding, injection molding, thermoforming and compression molding. Blow molding processes are preferred, which involve formation of a preform, whether by injection molding, compression molding or extrusion, and blow molding the preform in a blow mold. In injection blow molding, the materials are injected sequentially or simultaneously into a mold to form a preform having multiple layers. A typical injection blow molding operation is illustrated in U.S. Pat. No. 3,707,591. Sequential injection of plastic materials to obtain a multilayer preform in an injection blow molding process is illustrated in U.S. Pat. Nos. 4,413,974 and 4,990,301. Shooting pots preferably are employed as a buffer between the plastic extruders and the injection molds to expedite production and/or to provide premeasured amounts of relevant materials, as illustrated for example in U.S. Pat. No. 5,098,274. Exemplary extrusion blow molding processes are illustrated in U.S. Pat. Nos. 3,031,718, 3,114,594, 3,409,710 and 5,188,849. Exemplary reheat blow molding processes are illustrated in U.S. Patent documents 4,550,043, 4,990,301 and 2004/0091652.

FIG. 4 is a schematic diagram of a mold system in accordance with another aspect of the disclosure. The resin for layers A and C is fed through an extruder 14 to a molding system 16, which can be of any suitable type. In the same manner, resin for layer B is fed through an extruder 18 to molding system 16. Inert gas is fed through one or both extruders running a heat sensitive material to alleviate or avoid oxidation. More specifically, inert gas is fed from a suitable source through at least extruder 18 for barrier resin layer B, and preferably through both extruders 14,18, to reduce or prevent oxidation of the plastic materials as the materials flow through the extruders. This feature is particularly advantageous in connection with the barrier resin material flowing through extruder 18 inasmuch as barrier resin material is often highly susceptible to oxidation, which reduces the effectiveness of the barrier properties of the material.

FIG. 5 illustrates a further aspect of the disclosure as applied specifically to blow molding containers. A blow mold 20 includes a pair of opposed mold sections 22, 24 that together form a blow mold cavity 26. A preheated preform 28 is placed within mold 20, and air or other suitable gas is applied to the interior of preform 28 to blow the preform to the confines of cavity 26. (A preform for an injection blow molding operation or a reheat blow molding operation is illustrated by way of example.) A stretch rod or the like may or may not be employed in combination with the pressurized blow gas. In accordance with another aspect of the present disclosure, heat is applied to mold sections 22,24 from a suitable heater 30—i.e., independently of the heat in preform 28. Heater 30 may be of any suitable type, such as an electrical heater or means for applying a heated fluid (gas or liquid) to the mold sections. For example, blow mold temperature can be maintained at a desired level by conditioning a fluid circulating through the blow mold. Application of heat to the mold sections prior to and/or during the blow molding operation is to be contrasted with the usual procedure of extracting heat from the mold sections during operation. It has been found that application of heat to the mold sections helps reduce molded-in stresses, and improves the surface finish and the impact strength of the blow-molded container.

FIG. 5 also illustrates another aspect of the disclosure, wherein the blow gas (such as air) is fed through a conditioner 32 prior to application to the preform 28. Conditioning of the blow gas improves the properties of the blow-molded container. For example, heating the blow air reduces mold stresses, improves surface characteristics and improves drop impact strength in the molded container. This, in turn, reduces or eliminates any need for post-mold stress relieving operations. Molded-in stresses can be of particular concern in connection with engineering materials, such as cyclic olefin polymers and copolymers. These stresses can cause craze or cracks in containers when exposed to certain chemicals, cryogenic or elevated temperatures, or gamma radiation.

There thus have been disclosed a blow molded plastic container having particular application for the pharmaceutical industry, and a method of forming such a container. The disclosure has been presented in conjunction with several exemplary embodiments and implementations, and additional modifications and variations have been discussed. Other modifications and variations readily will suggest themselves to persons of ordinary skill in the art in view of the foregoing description. The disclosure is intended to embrace all such modifications and variations as fall within the spirit and broad scope of the appended claims.

1. A blow molded plastic container that includes a multilayer sidewall having at least three consecutive layers A, B and C,
said layers A and C being of identical plastic composition, and of a composition different from said layer B,
said layers A and C being of a composition selected from the group consisting of cyclic olefin polymers, cyclic olefin copolymers, acrylonitriles and blends thereof,
said layer B being of a composition selected from the group consisting of cyclic olefin polymers, cyclic olefin copolymers, polycarbonates and blends thereof.

2. A blow molded plastic container that includes a multilayer sidewall having at least three consecutive layers A, B and C,
said layers A and C being of identical plastic composition, and of a composition different from said layer B,
said layers A and C being of a composition selected from the group consisting of polycarbonates, acrylonitriles and blends thereof,
said layer B being of a composition selected from the groups consisting of nylons, polycarbonates and blends thereof.

3. A blow molded plastic container that includes a multilayer sidewall having at least three consecutive layers A, B and C,
said layers A and C being of identical plastic composition, and of a composition different from said layer B,
said layers A and C being of acrylonitrile composition, and said layer B being of ethylene vinyl alcohol composition.

4. A method of making a multilayer plastic container, which includes the steps of:
(a) feeding at least two plastic materials through associated extruders,
(b) forming a preform having at least two layers respectively consisting of said at least two plastic materials, and
(c) blow molding said preform into a plastic container,
characterized in that said step (a) includes feeding inert gas through at least one of said extruders to prevent oxidation of the plastic material in said at least one extruder.

5. The method set forth in claim 4 wherein said step (c) is carried out by blow molding said preform within a blow mold, characterized by applying heat to said blow mold independently of said preform.

6. The method set forth in claim 5 wherein said step (c) is carried out by applying gas under pressure to the preform, characterized in that the gas is conditioned prior to feeding to the preform.

7. A method of making a multilayer plastic container, which includes the steps of:
(a) feeding at least two plastic materials through associated extruders,
(b) forming a preform having at least two layers respectively consisting of said at least two plastic materials, and
(c) blow molding the preform into a plastic container,
characterized in that said step (a) includes feeding barrier resin through one of said extruders and feeding inert gas through said one extruder to prevent oxidation of said barrier resin.

8. A method of making a multilayer plastic container, which includes the steps of:
(a) feeding at least two plastic materials through associated extruders,
(b) injecting the plastic materials into a mold to form a preform having at least two layers, and
(c) blow molding said preform into a plastic container,
characterized in that said step (a) includes feeding inert gas through at least one of said extruders to prevent oxidation of the plastic material in said at least one extruder.

9. A method of making a multilayer plastic container, which includes the steps of:
(a) feeding at least two plastic materials through associated extruders,
(b) forming a preform having at least two layers respectively consisting of said at least two plastic materials, and
(c) blow molding said preform into a plastic container within a blow mold,
characterized by applying heat to said blow mold independently of said preform.
